(19) United States
(12) Patent Application Publication
(10) Pub. No.: US 2010/0214235 A1
(43) Pub. Date: Aug. 26, 2010

(54) Electronic Device and Method of Touch Screen Input Detection

(75) Inventors: Shuli Shmaya, Tel-Aviv (IL); Yoni Wortzman, Tel-Aviv (IL); Dror Geva, Herzelia (IL)

Correspondence Address: MOTOROLA INC, 600 NORTH US HIGHWAY 45, W4 - 39Q, LIBERTYVILLE, IL, 60048-5343, US

(73) Assignee: Motorola , Inc., Schaumubrg, IL (US)

(21) Appl. No.: 12/521,921

(22) PCT Filed: Oct. 31, 2007
(86) PCT No.: PCT/US07/83107

§ 371 Date: May 6, 2010

(30) Foreign Application Priority Data
Jan. 3, 2007 (GB) 0700053.2

(51) Int. Cl. G06F 3/041

(52) U.S. Cl. 345/173

(57) ABSTRACT

There is provided a method (700) of touch screen input detection comprising the steps of detecting an initial touch event on a touch sensor (720); detecting a change in the detected touch event; and determining (770) that the change in the touch event is due to a further touch on the touch sensor whilst the initial touch event is maintained. An electronic device is also described.

### TECHNICAL FIELD

The technical field relates generally to an electronic device and method of touch screen input detection and an apparatus therefor.

### BACKGROUND

Touch screen devices are operated by physically touching a touch-sensitive screen of an electronic device, either with a finger or a suitable mechanical device, such as a pen or stylus. Touch screen technology is used in a variety of applications, including point-of-sale systems, public information systems, industrial control systems, etc. In a case where electronic devices have smaller touch-screens, such as personal digital assistants (PDAs), a suitable stylus is normally provided with an electronic device. The stylus, when not in use, is usually stored in a pocket or slot in or on the electronic device itself.

A problem with known touch screen technology is that a user often needs to perform complicated tasks that require a more complicated user input method than simply touching the screen. For example, a user may need to manipulate menus, copy/paste text, etc. To execute such tasks, the user is required to remove the stylus from the touch screen, and then make use of a special function toolbar area.

Alternatively, a user may be required to touch and hold for a predefined time, until a special menu pops up for the user to manipulate or further select a displayed icon.

A yet further alternative is that a user may be required to hold and drag an icon displayed on the touch screen in order to move the icon or initiate some feature or function of the electronic device containing the touch screen.

In any case, it is problematic for a processor and touch sensor arrangement in the electronic device to accurately ascertain which of the above touch operations a user wished to implement. Furthermore, any timing sensitive operations require additional configuration in order to cope with ‘slow’ reaction users.

Thus, there exists a need for providing an improved electronic device comprising a touch screen and method of touch screen input detection.

### SUMMARY OF THE INVENTION

According to the invention in a first aspect there is provided a method of touch screen input detection as defined in claim 1 of the accompanying claims.

According to the invention in a second aspect there is provided an electronic device comprising a touch screen being as defined in claim 13 of the accompanying claims.

According to the invention in a third aspect there is provided an electronic device adapted to be detected by a device monitoring system as defined in claim 24 of the accompanying claims.

According to the invention in a fourth aspect there is provided a computer-readable storage element as defined in claim 25 of the accompanying claims.

Further features of the invention are as defined in the accompanying dependent claims and are disclosed in the embodiments of the invention to be described.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates an example of a touch screen device according to an embodiment of the invention.

FIG. 2 illustrates an example of a touch sensor.

FIGS. 3 to 5 illustrate the electrical properties of the touch sensor of FIG. 2.

FIG. 6 illustrates a functional representation of an example of a touch screen apparatus.

FIG. 7 illustrates a method of touch screen input detection according to an exemplary embodiment of the invention.

FIG. 8 illustrates a touch screen device, and a touch screen input device adapted for use therewith, according to embodiments of the invention.

### DESCRIPTION OF EMBODIMENTS OF THE INVENTION

Before describing in detail embodiments that are in accordance with the present invention, it should be observed that the embodiments reside primarily in combinations of apparatus components related to a touch screen device. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or ‘processing devices’) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the touch screen operation described herein.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a ‘processing device’ for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The embodiments described herein aim to provide a user with additional touch screen operation, whilst maintaining the ease of use and intuitiveness of traditional input devices. In particular, it is envisaged that embodiments of the invention may be readily applied to a large touch screen, where an initial touch point may be created by a user using a forefinger, with a second distal contact created using the user's little finger. Those skilled in the art will realize that the above recognized advantages and other advantages described herein are merely exemplary and are not meant to be a complete rendering of all of the advantages of the various embodiments of the present invention.

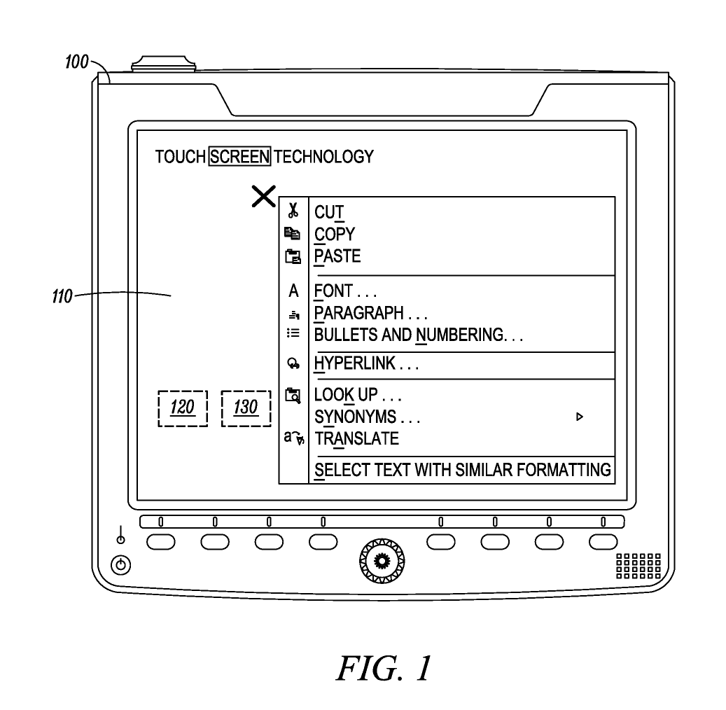

Referring now to the drawings, and in particular FIG. 1, there is illustrated an example of a touch screen device 100 according to an embodiment of the invention. Those skilled in the art, however, will recognize and appreciate that specifics of this illustrative example are not specifics of the invention itself and that teachings set forth herein are applicable in a variety of alternative settings. For example, since the teachings described herein do not depend on a specific touch screen or touch screen input device as illustrated, they may be applied to any type of touch screen device. As such, alternative implementations of using different types of touch screens and/or touch screen input devices are contemplated and are within the scope of various teachings described herein, as defined by the appended claims.

The touch screen device 100, illustrated in FIG. 1, comprises a touch-sensitive screen 110 adapted to display information, features, controls, etc. to a user of the touch screen device 100.

The touch screen 110 is also adapted to detect when a user ‘touches’ the touch screen 110, for example with a finger, pen, stylus, etc. Upon detecting such a touch, sensors behind the touch screen 110 provide a signal to, for example, a processor 120 or application program 130 running on the touch screen device 100, indicating that a touch has been detected, and providing an indication as to where on the touch screen 110 the touch was detected.

The processor 120 or application program 130 is then able to perform a function, provide a feature, or otherwise execute appropriate actions in response to the information received, following detection of the touch.

Touch screen technology is used in a variety of applications, including point-of sale systems, public information systems, industrial control systems, etc.

A touch screen input system in accordance with embodiments of the invention comprises a touch sensor, a controller card and a software driver. An example of a suitable touch sensor is a resistive touch sensor, comprising a normal glass panel. A conductive layer and a resistive layer are provided over the surface of the glass panel. These two layers are often held apart by spacers, and a scratch-resistant layer is on top of the resistive layer.

An electrical current runs through each of the conductive and resistive layers, while the touch screen is operational. When a user touches the screen, the conductive and resistive layers make contact in a region touched by the user. This causes a change in electrical paths in both an ‘X’ and ‘Y’ plane (as explained below). Hereafter, voltage measurements in the ‘X’ and ‘Y’ planes will be described as if the two planes are perpendicular to one another. However, it is envisaged that in some applications, the planes may be substantially perpendicular to one another, given design tolerances of the respective conductive and resistive layers, or indeed any different plane such that a voltage measured on one plane is unaffected by a voltage appearing on the other plane. Furthermore, it is envisaged that embodiments of the invention may be applied in a ‘Z’ plane direction, together with an ‘X’ plane and/or ‘Y’ plane.

This change is detected, and coordinates of a point of contact are calculated by the controller card. Once the coordinates are known, the software driver translates the touch into a signal that a processor 120 is able to interpret, much as a computer mouse driver translates a mouse's movements into a click or a drag.

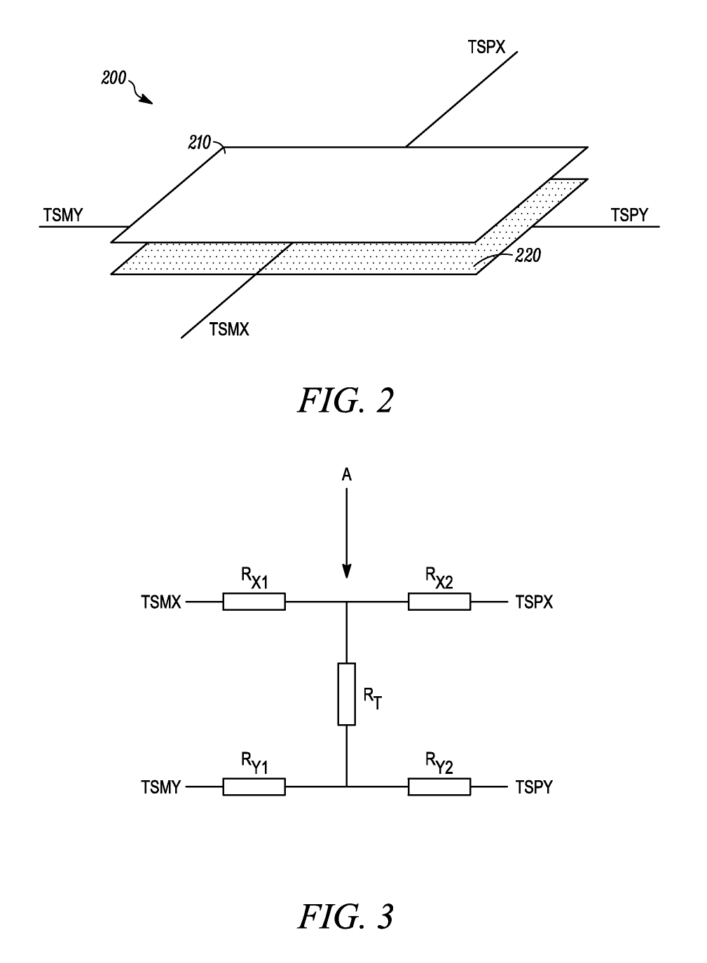

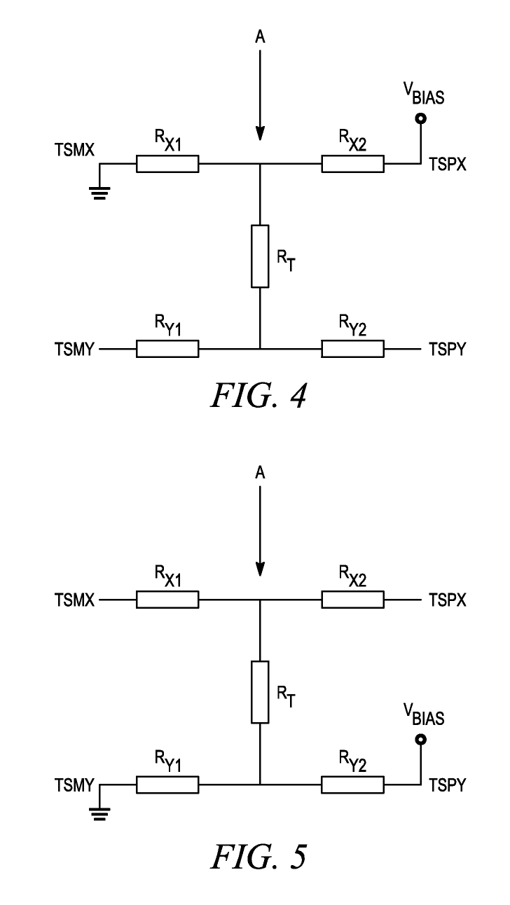

Referring now to FIG. 2, there is illustrated an example of a touch sensor 200 in accordance with an embodiment of the invention and comprising a first layer 210 and a second layer 220. The first layer 210 has contacts referred to as Touch Screen Positive X-plate (TSPX) and Touch Screen Negative X-plate (TSMX) connected to opposing edges along an ‘X’ axis. The second layer 220 has contacts Touch Screen Positive Y-plate (TSPY) and Touch Screen Negative Y-plate (TSMY) connected to opposing edges along a ‘Y’ axis. FIG. 3 illustrates electrical properties of the first and second layers 210, 220 when a user touches the screen at point ‘A’.

In order to determine the coordinates at which the user touches the touch screen, two position measurements, one in each of the ‘X’ and ‘Y’ axes, are required. The first position measurement is obtained by applying a bias voltage across an ‘X’ plate, namely the first layer 210, as illustrated in FIG. 4. A voltage across a ‘Y’ plate, namely the second layer 220 is then measured. The measured voltage across the ‘Y’ plate is proportional to the ‘X’ coordinate for a point at which the user touches the screen.

In order to obtain a ‘Y’ coordinate, a bias voltage across the ‘X’ plate is removed, and a bias voltage is applied across the ‘Y’ plate, as illustrated in FIG. 5. The voltage across the ‘X’ plate is then measured, and which is proportional to the ‘Y’ coordinate for the point at which the user touches the screen.

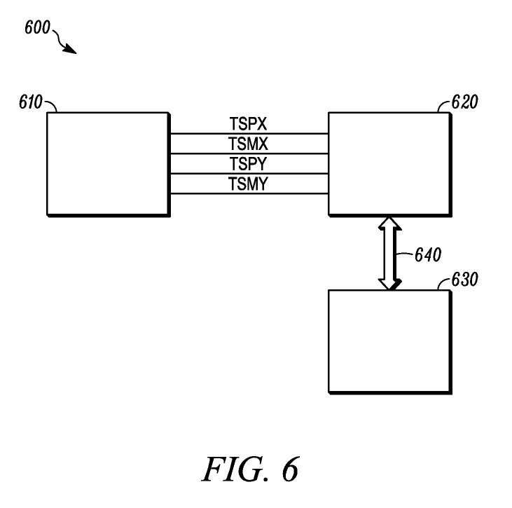

Referring now to FIG. 6, there is illustrated a functional representation of an example of a touch screen apparatus 600, adapted to support embodiments of the invention. The touch screen apparatus 600 comprises a touch sensor 610, a controller 620 and a software driver 630.

For the embodiment illustrated in FIG. 6, the touch sensor 610 is akin to the touch sensor 200 of FIG. 2, with contacts TSPX, TSMX, TSPY and TSMY coupled to the controller 620. The controller 620 is coupled to the software driver 630 by way of communication channel 640, or other suitable mechanism. It is envisaged that the communication channel 640 is implementation independent.

For example, it is envisaged that a suitable communication channel 640 may be the AC97 Protocol™ used by Philips™ UCB 1400 touch controller, or a serial-parallel interface (SPI) protocol, such as a BURR BROWN™ ADS7846 touch controller. The main purpose of the communication channel 640 is to transfer the touch points that are captured by the touch controller to the software driver 630. It is also envisaged that the software driver 630 may be in the form of an integrated circuit (IC) and may comprise any host controller incorporating hardware, firmware and/or software modules, such as the Intel Pentium™, Intel PXA27X™, Freescale™ MX1 . . . .

The controller 620 is capable of detecting a ‘touch event’ on the touch sensor 610, and determines coordinates of the touch event by way of the contacts TSPX, TSMX, TSPY and TSMY, as described above. Thereafter, the controller 620 may provide this information to the software driver 630.

The information provided to the software driver 630 by the controller 620 may include, by way of example only, ‘pen down’ events, touch coordinates, ‘pen up’ events, etc. For clarity, the term ‘pen down’ refers to an initial touch on the touch sensor by a finger, pen, stylus, etc., and the term ‘pen up’ refers to a removal of a touch from the touch sensor by the finger, pen, stylus, etc.

An initial touch, or ‘pen down’ event, may be detected by the controller 620 using a polling mechanism. In this manner, the controller 620 samples voltages across the ‘X’ and ‘Y’ plates (as described above) at constant time intervals, and records a touch, or ‘pen down’ event, when sampled levels are within a predefined range.

Alternatively, an initial touch, or ‘pen down’ event, may be detected by way of recognition of voltage level changes across the contacts TSPX, TSMX, TSPY and TSMY. In this manner, the controller 620 applies a constant voltage across one of either the ‘X’ or ‘Y’ plates of the touch sensor 610, and monitors the affected voltage across the other of the plates.

In an exemplary embodiment of the invention, voltage level recognition may be used during a power conservation mode, for example when no user input has been received for a period of time. Upon detection of a voltage level change caused by an initial touch, power conservation mode is exited and, say, a polling mechanism is subsequently used to detect touches, etc., whilst not operating in power conservation mode.

Referring back to FIG. 1, the touch screen device 100 may be further adapted to, following detection of an initial first touch, detect a further touch whilst the initial touch is generally maintained. In response to detecting the further touch, the touch screen device 100 may then execute an additional action.

More precisely, the touch screen 110 may be adapted to detect a further touch thereon, whilst an initial first touch is generally maintained. In this embodiment, the touch screen 110, upon detection of the further touch, provides a signal to, for example, a processor 120 or application program 130, indicating that a further touch has been detected.

Upon receipt of this signal from the touch screen 110, the processor 120 then performs an additional function, provides an additional feature, or otherwise may execute appropriate additional actions, in response to the information received following detection of the further touch.

For example, in the embodiment illustrated in FIG. 1, a first touch is detected on a part of the touch screen 110 generally in a region corresponding to where the word ‘Screen’ is displayed. The touch screen 110 then provides a signal to the processor 120 (and/or application 130, which in one embodiment of the invention may be running on the processor 120) of the touch screen device 100, indicating that an initial, first touch has been detected, and providing an indication as to where on the touch screen 110 the touch was detected.

Upon receipt of the signal indicating that a first touch has been detected, the processor 120 or application program 130 running thereon, recognises that a touch has been detected in the region of the word ‘Screen’, and selects the word, for example as illustrated by the word being highlighted.

As will be appreciated by a skilled artisan, the function of selecting a word may require not only a ‘touch’ to be detected, but also the ‘touch’ to be moved, or ‘dragged’ across the word to be selected, as is known in the art.

Subsequently, and whilst the first touch is maintained for example without a ‘pen up’ event being detected; the touch screen 110 detects a further touch, for example at point ‘X’ on the touch screen 110. Upon detection of this further touch, the touch screen 110 provides a signal to the processor 120, or application program 130 running thereon, indicating that the further touch has been detected.

Upon receipt of the signal indicating that a further touch has been detected, the processor 120, or application program 130 running thereon, recognises that a further touch has been detected, and displays a menu of options for a user of the touch screen device 100 to select from.

As will be appreciated by a skilled artisan, the further touch in this example provides similar functionality to that of a ‘right click’ operation when using a mouse on a standard computer system. Such functionality, namely an ability of a user to quickly and easily access options, greatly improves a user's experience compared to known touch screen operation.

It is envisaged that the invention is not limited to a detection of a further touch causing a menu to be displayed. For example, the detection of the further touch may cause any alternative feature or functionality to be implemented, depending on the location and characteristics of the initial and/or further touch, and the processor 120 and/or application program 130 to which the indication is provided.

Referring back to FIG. 6, an exemplary embodiment of the invention will be described in further detail. In this embodiment of the invention, the touch screen device 600 is adapted to detect an additional, substantially concurrent touch on the touch sensor 610. For example, when the controller 620 detects a ‘pen down’ event, it continues to poll the touch sensor 610, sampling voltages across both ‘X’ and ‘Y’ plates. Upon detection of a change in the voltages across the ‘X’ and ‘Y’ plates, the controller 620 and/or software driver 630 determines whether the change is due to:

(i) a ‘pen up’ event;

(ii) a change in touch coordinates; or

(iii) an additional touch on the touch sensor 610.

For example, when the controller 620 detects a change in the voltages across the ‘X’ and ‘Y’ plates indicating a substantially open circuit between the two plates, this indicates that a ‘pen up’ event has been detected. That is to say, the detected touch that caused the ‘pen down’ event has no longer been maintained.

Conversely, when the controller 620 detects a change in the voltages across the ‘X’ and ‘Y’ plates, other than such as to indicate a ‘pen up’ event, the controller 620 and/or software driver 630 may assume that the change is caused by a change in touch coordinates, for example due to a finger being dragged across the touch sensor 610, or by an additional touch on the touch sensor 610, with the initial touch being maintained.

The movement of, for example, a user dragging their finger, a pen, a stylus, etc. across the touch sensor 610 is limited. That is to say, it is reasonable to assume that for a dragging action there is a maximum speed at which a finger/pen/stylus will move across the touch sensor 610. Therefore, it is further reasonable to assume that for a dragging action there is a maximum distance that a finger/pen/stylus will move in a given period of time.

When the controller 620 detects a change in the voltages across the ‘X’ and ‘Y’ plates, the new voltages will thus suggest new coordinates at which a touch is occurring on the touch sensor 610. By calculating a distance between previous coordinates and new suggested coordinates, and using a time difference between voltage samples, an approximation of a speed at which a finger/pen/stylus would have had to have traveled can be calculated.

In this manner, if the calculated speed is below a maximum value, it can be assumed that the change in voltages may be due to a finger, etc. being dragged across the touch sensor 610, and thus a change in touch coordinates can be determined.

Conversely, if the calculated speed exceeds a maximum value, it may be assumed that the change in voltages is not due to a finger, etc. being dragged across the touch sensor 610, but rather is a consequence of an additional touch on the touch sensor 610.

As will be appreciated by a skilled artisan, the ability of the controller 620 and/or software driver 630 to detect an additional, substantially concurrent touch on the touch sensor 610 provides an advantage of allowing an extended input mechanism for touch screen devices, above and beyond just the normal pen down, drag, and pen up events. In this manner, additional functionality may be provided in association with the extended input mechanism.

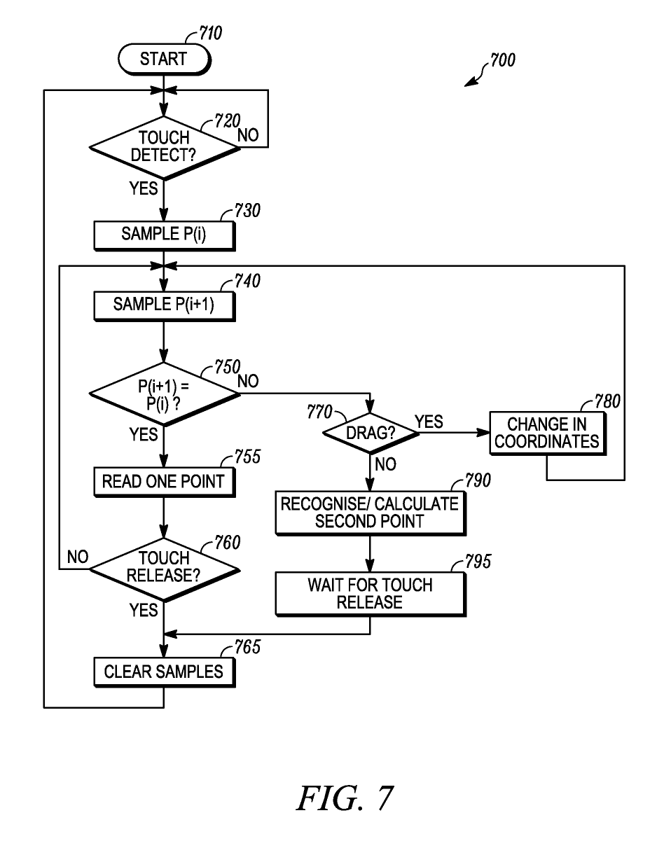

Referring now to FIG. 7, there is illustrated a method 700 of touch screen input detection according to an exemplary embodiment of the invention. The method 700 starts at step 710. Next, at step 720, a determination is made as to whether a touch event, such as an initial touch is detected. If no initial touch is detected in step 720, the method 700 loops back to step 720. If an initial touch is detected in step 720, the method 700 moves on to step 730. As will be appreciated by a skilled artisan, the invention is not limited to a ‘polling’ mechanism until the initial touch is detected. It is envisaged that any alternative method may be implemented to determine when a touch is detected. For example, step 720 may simply wait until a touch is detected, such as when a voltage level change is detected. Upon detecting a touch, the method would then move on to step 730.

At step 730, an initial sample P(i) is taken of values relating to a location of a detected touch. For example, it is envisaged that two position measurements may be sampled, one for each of the ‘X’ and ‘Y’ planes. Next, in step 740, a further sample P(i+1) is taken of the location of the detected touch. Having taken the further sample P(i+1), the further sample P(i+1) is compared to the initial sample P(i), in step 750. If the further sample P(i+1) is substantially equal to, or at least within a predetermined range of, the initial sample P(i), it may be assumed that a single stationary touch has been detected. Here, the method 700 moves to step 755, where a single touch point is read. In the context of a touch screen device, such as the touch screen device 100 of FIG. 1, information relating to the location of this single touch point is provided to, for example, the processor 120 of the touch screen device 100, or an application program 130 running thereon.

Next, in step 760, it is determined whether a touch release, or ‘pen up’ event, has been detected. If a touch release event is not detected in step 760, then the method 700 loops back to step 740, where a new further sample P(i+1) is taken. If it is determined that a touch release has been detected in step 760, the method 700 moves on to step 765, where samples are cleared. In the context of a touch screen device, such as the touch screen device 100 of FIG. 1, a signal indicating that a touch release has been detected is provided to, for example, the processor 120 of the touch screen device 100, or an application program 130 running thereon. The method 700 then loops back to step 720.

Referring back to step 750, if the further sample P(i+1) is not subsequently equal to the initial sample P(i), the method 700 moves to step 770 where it is determined whether a difference in sample values is due to a detected touch comprising a ‘drag’, i.e. movement of a touch across the touch screen, causing a change in touch coordinates. This may be achieved by calculating distances between the coordinates of the two samples, and using the time between the two samples to provide an approximate calculation of speed at which a finger, pen or stylus would have had to have traveled. If the calculated speed is below a predetermined value, it may be assumed that the difference in sample values could be due to the finger/pen/stylus being dragged across the touch screen.

If it is determined that a drag has been detected, the method 700 moves to step 780, where a change in coordinates is read. In the context of a touch screen device, such as the touch screen device 100 of FIG. 1, a signal indicating that a drag has been detected is provided to, for example, the processor 120 of the touch screen device 100, or an application program 130 running thereon. This step may also comprise setting sample P(i) equal to sample P(i+1). The method 700 then loops back to step 740, where a new further sample P(i+1) is taken. If it is determined that the difference in sample values is not caused by a drag in step 770, it may be assumed that a further touch has been detected. That is to say, if the calculated speed is above the predetermined value, it can be assumed that the difference in sample values is due to a further touch being detected.

In step 790, the further touch point is recognised. In an exemplary embodiment a location of the further touch point is also calculated. Again, in the context of a touch screen device, such as the touch screen device 100 of FIG. 1, a signal indicating that a further touch has been detected may be provided to, for example the processor 120 of the touch screen device 100, or an application program 130 running thereon. In one embodiment of the invention, a location of the second (or further) touch point may be calculated by determining a new location of a combined voltage, where the combined voltage may be considered as a superposition of the initial touch and the second (or further) touch. For example, as the initial touch position is known, a second touch may then be recognised and the movement from the initial touch position to the combined location of the first and second touches may be interpolated to identify the location of the second touch position.

Next in step 795, the method 700 waits for a touch release. When a touch release is detected, the method 700 moves to step 765, where samples are cleared. Finally, the method 700 loops back to step 720. Thus, in accordance with the above-described embodiments, a method of touch screen input detection comprises detecting an initial touch event on a touch sensor, detecting a change in the detected touch event; and determining that the change in the touch event is due to a further touch on the touch sensor whilst the initial touch event is maintained. In this manner, a second touch of the touch sensor can be identified and used to trigger an operation or feature or execution of an action for the electronic device.

In one embodiment of the invention, the method of touch screen input detection comprises determining a location of the initial touch event in relation to the touch sensor, for example by performing a first position measurement, in a first plane of the touch screen and performing a second measurement in a second plane of the touch screen, substantially perpendicular to the first plane. In one embodiment, the determination of the location of the initial touch event may comprise applying a first bias voltage across a first plate of the touch sensor and measuring a first voltage across a second plate of the touch sensor to determine a first position measurement, and applying a second bias voltage across the second plate of the touch sensor and measuring a second voltage across the first plate to determine a second position measurement. Thus, in this manner, detecting a change in the detected touch event may comprise detecting a change in at least one position measurement.

In one embodiment, the detecting the change in the detected touch event may comprise determining whether the change in the touch event is due to at least one of the following:

(i) a ‘pen up’ event;

(ii) a change in touch coordinates;

(iii) an additional touch on the touch sensor.

In one embodiment of the invention, a change in the touch event may be due to a further touch on the touch sensor. Thus, determining a location of the further touch, in relation to the touch sensor or in relation to a location of the initial touch may be used to identify a characteristic of the determined further touch, for example whether it was a further touch or part of a ‘hold and drag’ operation. In this manner, the method may comprise calculating a distance between a location of the initial touch and a location of the further touch; calculating speed at which an element could travel from the location of the initial touch to the location of the further touch in an elapsed time; and if the calculated speed is above a predetermined value, deducing that the change in the touch event is due to a further touch being detected whilst the initial touch is maintained.

Further in this manner, and referring back to FIG. 1, a first signal may be provided to a processor 120 or application program 130 running on the electronic device 100, where the first signal may indicate that an initial touch event has been detected, and may also be indicative of the location of the initial touch event. In response to receiving the first signal, the processor 120 or application program 130 may perform a function, provide a feature, or execute one or more actions on the electronic device.

In one embodiment, detection of a further touch may enable the touch sensor to send a second signal to the processor 120 or application program 130 indicating that the further touch has been detected. In response to receiving the second signal, the processor 120 or application program 130 may perform an additional function, provide an additional feature, or execute one or more additional action(s).

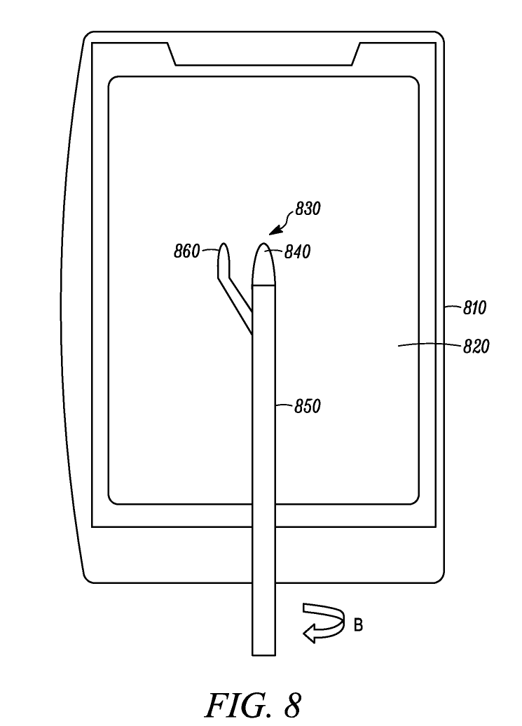

Referring now to FIG. 8, there is illustrated an electronic device 810 comprising a touch screen 820. Also illustrated is a touch screen input device 830 adapted for use with an electronic touch screen device employing embodiments of the invention described herein.

Such a touch screen input device 830 is described in more detail in a corresponding co-pending patent application filed on the same day by the Applicant of the present invention {reference CM10420EI}. However, for completeness, a brief description of the touch screen input device 830 is provided below.

A user of the touch screen input device 830 is able to use the touch screen input device 830 to interact with the touch screen 820 using a primary contact element, which for the illustrated embodiment is in the form of a first contact tip 840 in a similar way to known touch screen input devices. The touch screen input device 830 further comprises a second contact tip 860 operatively coupled to a shaft 850, providing a user of the touch screen input device 830 with the ability to utilise additional touch screen functionality. The user of the touch screen input device 830 is able to use the primary contact element to, for example, select text or the like by touching (and perhaps dragging across) the touch screen 820. Then, whilst maintaining contact between the primary contact element and the touch screen 820, use the secondary contact element to establish a second point of contact on the touch screen 820.

In this manner, the second point of contact can additionally be detected by the electronic device 810, and in response thereto, provide the user with additional features or the like. For example, upon detection of pressure on the second point of contact, a processor 120 in the electronic device 100, coupled to the touch screen, may generate a signal to instigate a prompt window to be displayed to the user, thereby providing previously hidden features/functionality. For the touch screen input device 830 illustrated in FIG. 8, the second contact tip 860 may be able to establish the second point of contact, for example, by way of the user rotating the shaft 850 of the touch screen input device 830 along its axis, as illustrated by arrow ‘B’.

In the foregoing specification, specific embodiments of the present invention have been described. However, one of ordinary skill in the art appreciates that various modifications and changes can be made without departing from the scope of the present invention as set forth in the claims below. For example, the above-described embodiments illustrate determining two points of contact on a touch screen and the associated processing related to these two points of contact. However, the teachings herein can be extended to embodiments wherein more than two points of contact are detected, with the associated processing.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions.

The terms ‘comprises’, ‘comprising, ’ ‘has’, ‘having, ’ ‘includes’, ‘including, ’ ‘contains’, ‘containing’ or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by ‘comprises . . . a’, ‘has . . . a’, ‘includes . . . a’, ‘contains . . . a’ does not, without more constraints, preclude the existence of additional identical elements in the process, method, article, or apparatus that comprises, has, includes, contains the element. The terms ‘a’ and ‘an’ are defined as one or more, unless explicitly stated otherwise herein.

The terms ‘substantially’, ‘essentially’, ‘approximately’, ‘about’ or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term ‘coupled’ as used herein is defined as connected, although not necessarily directly and not necessarily mechanically. A device or structure that is ‘configured’ in a certain way is configured in at least that way, but may also be configured in ways that are not listed.

Thus, an improved method of touch screen input detection, and an apparatus therefor, have been described wherein the aforementioned disadvantages associated with prior art arrangements have been substantially alleviated.

1. A method of touch screen input detection comprising:
detecting an initial touch event on a touch sensor;
detecting a change in the detected touch event; and
determining that the change in the touch event is due to a further touch on the touch sensor whilst the initial touch event is maintained.

2. The method of touch screen input detection of claim 1 further including determining a location of the initial touch event in relation to the touch sensor.

3. The method of touch screen input detection of claim 2 further including determining the location of the initial touch event by performing a first position measurement, in a first plane of the touch screen and performing a second measurement in a second plane of the touch screen substantially perpendicular to the first plane.

4. The method of touch screen input detection of claim 3 further including determining the location of the initial touch event comprises applying a first bias voltage across a first plate of the touch sensor and measuring a first voltage across a second plate of the touch sensor to determine a first position measurement, and applying a second bias voltage across the second plate of the touch sensor and measuring a second voltage across the first plate to determine a second position measurement.

5. The method of touch screen input detection of claim 3 further including the step of detecting the change in the detected touch event comprises detecting a change in at least one position measurement.

6. The method of touch screen input detection of claim 1, wherein the step of detecting the change in the detected touch event comprises determining whether the change in the touch event is due to at least one of the following:
a pen up event;
(ii) a change in touch coordinates; and
(iii) an additional touch on the touch sensor.

7. The method of touch screen input detection of claim 1, further including determining that the change in the touch event is due to a further touch on the touch sensor comprises determining a location of the further touch in relation to the touch sensor or in relation to a location of the initial touch.

8. The method of touch screen input detection of claim 7 further including determining that the change in the touch event is due to a further touch on the touch sensor comprises:
calculating a distance between the location of the initial touch and a location of the further touch;
calculating speed at which an element could travel from the location of the initial touch to the location of the further touch in an elapsed time; and if the calculated speed is above a predetermined value,
deducing that the change in the touch event is due to a further touch being detected whilst the initial touch is maintained.

9. The method of touch screen input detection of claim 1 further including providing a first signal to a processor or application running on an electronic device comprising the touch screen, wherein the first signal indicates that an initial touch event has been detected, and is indicative of the location of the initial touch event.

10. The method of touch screen input detection of claim 9 further including performing a function, providing a feature, or executing one or more actions, by the processor or application, in response to receiving the first signal.

11. The method of touch screen input detection of claim 9 further including providing a second signal to the processor or application indicating that the further touch has been detected.

12. The method of touch screen input detection of claim 11 further including performing an additional function, providing an additional feature, or executing one or more additional action(s) by the processor or application in response to receiving the second signal.

13. An electronic device comprising: a touch screen having a touch sensor; and a controller coupled to the touch screen sensor, and capable of detecting an initial touch event on the touch sensor; wherein the controller is adapted to detect a change in the touch event and determine whether the detected change in the touch event is due to a further touch on the touch sensor whilst the initial touch event is maintained.

14. The electronic device of claim 13 wherein the controller determines a location of the initial touch event in relation to the touch sensor, using a first position measurement, in a first plane of the touch sensor and a second measurement in a second plane of the touch sensor substantially perpendicular to the first plane.

15. The electronic device of claim 13 further comprising at least one of a processor coupled to the controller and an application running on the electronic device, and wherein pursuant to detecting the initial touch event, the controller provides a first signal to the processor or application running on the electronic device indicating that a touch event has been detected, wherein the first signal provides an indication as to the location of the touch event.
